(19) United States
(12) Patent Application Publication
(10) Pub. No.: US 2012/0052384 A1
(43) Pub. Date: Mar. 1, 2012

(54) COMPOSITION FOR POSITIVE ELECTRODE OF RECHARGEABLE LITHIUM BATTERY AND RECHARGEABLE LITHIUM BATTERY INCLUDING POSITIVE ELECTRODE

(75) Inventors: Sae-Weon ROH, Yongin-si (KR); Yong-Chul Park, Yongin-si (KR); Sung-Soo Kim, Yongin-si (KR); So-Hyun Hur, Yongin-si (KR); In-Haeng Cho, Yongin-si (KR)

(73) Assignee: Samsung SDI Co., Ltd., Yongin-si (KR)

(21) Appl. No.: 13/177,469

(22) Filed: Jul. 6, 2011

(30) Foreign Application Priority Data
Aug. 25, 2010 (KR) 10-2010-0082516

(51) Int. Cl. H01M 4/62; B05D 5/12; H01M 4/139; H01M 4/60

(52) U.S. Cl. 429/215; 252/182.1; 252/500; 427/126.3; 427/58; 29/623.5

(57) ABSTRACT

Disclosed is a composition for a positive electrode of a rechargeable lithium battery that includes a positive active material, a binder, and an ionic liquid including a borate-based anion.

### CROSS-REFERENCE TO RELATED APPLICATIONS

This application claims priority to and the benefit of Korean Patent Application No. 10-2010-0082516 filed in the Korean Intellectual Property Office on Aug. 25, 2010, the entire contents of which are incorporated herein by reference.

### BACKGROUND

1. Field

This disclosure relates to a composition for a positive electrode of a rechargeable lithium battery and a rechargeable lithium battery including the positive electrode.

2. Description of the Related Technology

Batteries transform chemical energy generated from an electrochemical redox reaction of a chemical material in the battery into electrical energy. Such batteries are divided into a primary battery, which should be disposed of after the energy of the battery is all consumed, and a rechargeable battery, which can be recharged many times.

The rechargeable battery can be charged/discharged many times based on the reversible transformation between chemical energy and electrical energy. Recent developments in high-tech electronics has allowed electronic devices to become small and light in weight, which leads to an increase in portable electronic devices.

As a power source for such portable electronic devices, the demands for batteries with high energy density are increasing and research on lithium rechargeable battery is actively being pursued.

The rechargeable lithium battery is fabricated by injecting electrolyte into a battery cell, which includes a positive electrode including a positive active material capable of intercalating/deintercalating lithium ions and a negative electrode including a negative active material capable of intercalating/deintercalating lithium ions.

The positive active material includes composite oxides including lithium (Li) and various transition elements. Transition elements included in a positive active material may be eluted into an electrolyte at a high temperature. This reduces capacity of a rechargeable battery and cycle life. The present embodiments overcome the above problems and provide additional advantages as well.

### SUMMARY

One embodiment provides a composition for a positive electrode of a rechargeable lithium battery that reduces elution of transition elements from a positive electrode.

Another embodiment provides a rechargeable lithium battery including the positive electrode manufactured using the composition.

According to one embodiment, a composition for a positive electrode of a rechargeable lithium battery is provided that includes a positive active material, a binder, and an ionic liquid including a borate-based anion.

According to another embodiment, a rechargeable lithium battery is provided that includes a positive electrode, a negative electrode, and an electrolyte, wherein the positive electrode includes a positive active material, a binder, and an ionic liquid including a borate-based anion.

The borate-based anion may be selected from bis(oxalato)borate (BOB), difluorooxalatoborate (FOB), bis(malonato)borate (BMB), bis(perfluoropinacolato)borate (BPFPB), triborate (B₃O₇⁵⁻), tetraborate (B₄O₉⁶⁻), metaborate ([BO₂⁻]ₙ), or a combination thereof.

The ionic liquid includes one cation selected from a lithium cation, a substituted or unsubstituted imidazolium cation, a substituted or unsubstituted piperidinium cation, a substituted or unsubstituted pyrolidinium cation, a substituted or unsubstituted pyrazolium cation, a substituted or unsubstituted triazolium cation, a substituted or unsubstituted isotriazolium cation, a substituted or unsubstituted thiazolium cation, a substituted or unsubstituted oxazolium cation, a substituted or unsubstituted isooxazolium cation, a substituted or unsubstituted pyridazinium cation, a substituted or unsubstituted pyrimidinium cation, a substituted or unsubstituted pyrazinium cation, a substituted or unsubstituted pyridinium cation, a substituted or unsubstituted isothiazolium cation, a substituted or unsubstituted azathiazolium cation, a substituted or unsubstituted oxothiazolium cation, a substituted or unsubstituted oxaborolium cation, a substituted or unsubstituted dithiazolium cation, a substituted or unsubstituted selenozolium cation, a substituted or unsubstituted oxaphospholium cation, a substituted or unsubstituted pyrollium cation, a substituted or unsubstituted borolium cation, a substituted or unsubstituted furanium cation, a substituted or unsubstituted thiophenium cation, a substituted or unsubstituted pentazolium cation, a substituted or unsubstituted indolium cation, a substituted or unsubstituted indolinium cation, a substituted or unsubstituted tetrazolium cation, a substituted or unsubstituted benzofuranium cation, a substituted or unsubstituted dibenzofuranium cation, a substituted or unsubstituted benzothiophenium cation, a substituted or unsubstituted dibenzothiophenium cation, a substituted or unsubstituted thiadiazolium cation, a substituted or unsubstituted piperazinium cation, a substituted or unsubstituted morpholinium cation, a substituted or unsubstituted pyranium cation, a substituted or unsubstituted annolinium cation, a substituted or unsubstituted phthalazinium cation, a substituted or unsubstituted quinazolinium cation, a substituted or unsubstituted quinazalinium cation, a substituted or unsubstituted quinolinium cation, a substituted or unsubstituted isoquinolinium cation, a substituted or unsubstituted thazinium cation, a substituted or unsubstituted oxazinium cation, a substituted or unsubstituted azaannulenium cation, a substituted or unsubstituted phosphonium cation, a substituted or unsubstituted ammonium cation, or a combination thereof

The positive active material, the binder, and the ionic liquid may be respectively included at about 75 wt % to about 95 wt %, about 1 wt % to about 20 wt %, and about 0.1 wt % to about 15 wt % based on the total amount of the composition for a positive electrode.

The composition for a positive electrode may further include a conductive material, and the conductive material may be included at about 0.01 wt % to about 20 wt % based on the total amount of the composition for a positive electrode.

The positive electrode may further include an oxide layer surrounding the positive active material and obtained from the borate-based anion.

The positive electrode may further include an oxide disposed between the positive active materials and obtained from the borate-based anion.

The composition for a positive electrode may prevent a rapid decrease of battery capacity and a decrease of the cycle life by suppressing the transition element ion for a positive active material from being eluted into the electrolyte at a high temperature. Particularly, it may enlarge the field of applying a transition metal such as manganese that has been limited in application due to the elution into the electrolyte, so it may diversify the kinds of positive active material.

In addition, it may prevent thermal runaway in which a battery is damaged due to chemical structural instability in a positive electrode during a charge, so that it may enhance the thermal stability of the battery to prevent performance deterioration.

### BRIEF DESCRIPTION OF THE DRAWING

FIG. 1 is a schematic view showing a rechargeable battery in accordance with an embodiment.

### DETAILED DESCRIPTION

The present embodiments will be described more fully hereinafter with reference to the accompanying drawings, in which exemplary embodiments are shown. As those skilled in the art would realize, the described embodiments may be modified in various different ways, all without departing from the spirit or scope of the present embodiments.

As used herein, when a definition is not otherwise provided, the term “substituted” refers to one substituted with a substituent selected from a halogen (F, Br, Cl, or I), a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid group or a salt thereof, a C₁ to C₁₂ alkyl group, a C₂ to C₁₆ alkenyl group, a C₂ to C₁₆ alkynyl group, an aryl group, a C₇ to C₁₃ arylalkyl group, a C₁ to C₄ oxyalkyl group, a C₁ to C₂₀ heteroalkyl group, a C₃ to C₂₀ heteroarylalkyl group, a cycloalkyl group, a C₃ to C₁₅ cycloalkenyl group, a C₆ to C₁₅ cycloalkynyl group, a heterocycloalkyl group, and a combination thereof, instead of hydrogen of a compound.

As used herein, when a definition is not otherwise provided, the term “hetero” refers to one including 1 to 3 heteroatoms selected from N, O, S, and P.

In the drawings, the thickness of layers, films, panels, regions, etc., may be exaggerated for clarity. Like reference numerals designate like elements throughout the specification. It will be understood that when an element such as a layer, film, region, or substrate is referred to as being “on” another element, it may be directly on the other element or intervening elements may also be present. In contrast, when an element is referred to as being “directly on” another element, there are no intervening elements present.

Hereinafter, a composition for a positive electrode of a rechargeable lithium battery according to one embodiment will be described.

The composition for a positive electrode according to one embodiment includes a positive active material, a binder, a conductive material, and an ionic liquid.

For the positive active material, any compounds capable of reversibly intercalating and deintercalating lithium ions may be used without limitation. Examples of the positive active material include composite oxides including lithium (Li) and a metal selected from the group consisting of cobalt (Co), manganese (Mn), nickel (Ni), and combinations thereof.

Example of the compound include, for example, LiₐA_{1-b}D_{b}E₂ (wherein 0.90≦a≦1.8, 0≦b≦0.5); LiₐG_{1-b}D_{b}O_{2-c}J_{c} (wherein 0.90≦a≦1.8, 0≦b≦0.5, 0≦c≦0.05); LiₐG_{2-b}D_{b}O_{4-c}J_{c} (wherein 0.90≦a≦1.8, 0≦b≦0.5, 0≦c≦0.05); LiₐNi_{1-b-c}Co_{b}D_{c}E_{α} (wherein 0.90≦a≦1.8, 0≦b≦0.5, 0≦c≦0.05, 0<α≦2); LiₐNi_{1-b-c}Co_{b}D_{c}O_{2-α}J_{α} (wherein 0.90≦a≦1.8, 0≦b≦0.5, 0≦c≦0.05, 0<α<2); LiₐNi_{1-b-c}Co_{b}D_{c}O_{2-α}J₂ (wherein 0.90≦a≦1.8, 0≦b≦0.5, 0≦c≦0.05, 0<α<2); LiₐNi_{1-b-c}Mn_{b}D_{c}E_{α} (wherein 0.90≦a≦1.8, 0≦b≦0.5, 0≦c≦0.05, 0<α≦2); LiₐNi_{1-b-c}Mn_{b}D_{c}O_{2-α}J_{α} (wherein 0.90 ≦a≦1.8, 0≦b≦0.5, 0≦c≦0.05, 0<α<2); LiₐNi_{1-b-c}Mn_{b}D_{c}O_{2-α}J₂ (wherein 0.90≦a≦1.8, 0≦b≦0.5, 0≦c≦0.05, 0<α<2); LiₐNi_{b}G_{c}L_{d}O₂ (wherein 0.90≦a≦1.8, 0≦b≦0.9, 0≦c≦0.5, 0.001≦d≦0.1); LiₐNi_{b}Co_{c}Mn_{d}LₑO₂ (wherein 0.90≦a≦1.8, 0≦b≦0.9, 0 ≦c≦0.5, 0≦d≦0.5, 0.001≦e≦0.1); LiₐNiL_{b}O₂ (wherein 0.90≦a≦1.8, 0.001≦b≦0.1); LiₐCoL_{b}O₂ (wherein 0.90≦a≦1.8, 0.001≦b≦0.1); LiₐMnL_{b}O₂ (wherein 0.90≦a≦1.8, 0.001≦b≦0.1); LiₐMn₂L_{b}O₄ (wherein 0.90≦a≦1.8, 0.001≦b≦0.1); QO₂; QS₂; LiQS₂; V₂O₅; LiV₂O₅; LiRO₂; LiNiVO₄; Li_{(3-f)}Z₂(PO₄)₃ (0≦f≦2); Li_{(3-f)}Fe₂(PO₄)₃(0≦f≦2); and LiFePO₄.

Herein, A is selected from the group consisting of Ni, Co, Mn, and a combination thereof; D is selected from the group consisting of Al, Ni, Co, Mn, Cr, Fe, Mg, Sr, V, a rare earth element, and a combination thereof; E is selected from the group consisting of O, F, S, P, and a combination thereof; G is selected from the group consisting of Co, Mn, and a combination thereof; J is selected from the group consisting of F, S, P, and a combination thereof; L is selected from the group consisting of Al, Cr, Mn, Fe, Mg, La, Ce, Sr, V, and a combination thereof; Q is selected from the group consisting of Ti, Mo, Mn, and a combination thereof; R is selected from the group consisting of Cr, V, Fe, Sc, Y, and a combination thereof; and Z is selected from the group consisting of V, Cr, Mn, Co, Ni, Cu, and a combination thereof.

The positive active material may be included at about 75 wt % to about 95 wt % based on the total amount of the composition.

The binder improves binding properties of the positive active material particles to one another, and also with a current collector. Any material may be used for the binder without limitation if it does not cause a chemical change and improves adherence. Examples of the binder include polyvinyl alcohol, carboxylmethyl cellulose, hydroxypropylene cellulose, diacetylene cellulose, polyvinyl chloride, carboxylated polyvinyl chloride, polyvinyl difluoride, a polymer including ethylene oxide, polyvinylpyrrolidone, polyurethane, polytetrafluoroethylene, polyvinylidene fluoride, poly(vinylidene fluoride-hexafluoropropylene) (P(VdF-HFP)), polyethylene, polypropylene, styrene-butadiene rubber, acrylated styrene-butadiene rubber, an epoxy resin, nylon, or the like. Among them, poly(vinylidene fluoride-hexafluoropropylene) (P(VdF-HFP)) is preferable, wherein hexafluoropropylene (HFP) may further improve the adherence of the positive active material when being included at about 4 mol % to about 20 mol %.

The binder may be included at about 1 wt % to about 20 wt % based on the total amount of the composition.

The conductive material is included to improve electrode conductivity. Any electrically conductive material may be used as a conductive material unless it causes a chemical change. Examples of the conductive material include polyphenylene derivatives, natural graphite, artificial graphite, carbon black, acetylene black, ketjen black, carbon fiber, and metal powders and metal fiber including copper, nickel, aluminum, silver, or the like.

The conductive material may be omitted if not required, but if required, it may be included at about 0.01 wt % to 20 wt % based on the total amount of the composition.

The ionic liquid includes cations and anions, and it is a salt having liquid characteristics at room temperature.

The ionic liquid includes a borate-based anion. The borate-based anion may include any anion including a substituted or unsubstituted borate ion, and in one embodiment is a borate-based anion bound with oxygen. Such a borate-based anion may include, for example, one selected from bis(oxalato)borate (BOB), difluorooxalatoborate (FOB), bis(malonato)borate (BMB), bis(perfluoropinacolato)borate (BPFPB), triborate (B₃O₇⁵⁻), tetraborate (B₄O₉⁶⁻), metaborate ([BO₂⁻]ₙ), and a combination thereof.

The ionic liquid includes a lithium cation or a non-lithium cation. The non-lithium cation may include any cation without a lithium cation, for example a substituted or unsubstituted imidazolium cation, a substituted or unsubstituted piperidinium cation, a substituted or unsubstituted pyrrolidinium cation, a substituted or unsubstituted pyrazolium cation, a substituted or unsubstituted triazolium cation, a substituted or unsubstituted isotriazolium cation, a substituted or unsubstituted thiazolium cation, a substituted or unsubstituted oxazolium cation, a substituted or unsubstituted isoxazolium cation, a substituted or unsubstituted pyridazinium cation, a substituted or unsubstituted pyrimidinium cation, a substituted or unsubstituted pyrazinium cation, a substituted or unsubstituted pyridinium cation, a substituted or unsubstituted isothiazolium cation, a substituted or unsubstituted azathiazolium cation, a substituted or unsubstituted oxothiazolium cation, a substituted or unsubstituted oxaborolium cation, a substituted or unsubstituted dithiazolium cation, a substituted or unsubstituted selenozolium cation, a substituted or unsubstituted oxaphospholium cation, a substituted or unsubstituted pyrollium cation, a substituted or unsubstituted borolium cation, a substituted or unsubstituted furanium cation, a substituted or unsubstituted thiophenium cation, a substituted or unsubstituted pentazolium cation, a substituted or unsubstituted indolium cation, a substituted or unsubstituted indolinium cation, a substituted or unsubstituted tetrazolium cation, a substituted or unsubstituted benzofuranium cation, a substituted or unsubstituted dibenzofuranium cation, a substituted or unsubstituted benzothiophenium cation, a substituted or unsubstituted dibenzothiophenium cation, a substituted or unsubstituted thiadiazolium cation, a substituted or unsubstituted piperazinium cation, a substituted or unsubstituted morpholinium cation, a substituted or unsubstituted pyranium cation, a substituted or unsubstituted annolinium cation, a substituted or unsubstituted phthalazinium cation, a substituted or unsubstituted quinazolinium cation, a substituted or unsubstituted quinazalinium cation, a substituted or unsubstituted quinolinium cation, a substituted or unsubstituted isoquinolinium cation, a substituted or unsubstituted thazinium cation, a substituted or unsubstituted oxazinium cation, a substituted or unsubstituted azaannulenium cation, a substituted or unsubstituted phosphonium cation, a substituted or unsubstituted ammonium cation, and a combination thereof.

The borate-based anion may provide a borate oxide after the initial charge. The borate oxide may be present in a form of an oxide layer surrounding a part or the whole of the positive active material, or in a form of partially binding with the surface of the positive active material. In addition, the borate oxide may be present between positive active materials.

The borate oxide may be present in surroundings of the positive active material or around them, so as to suppress the transition element ion for a positive active material from being eluted into the electrolyte at a high temperature. Accordingly, it may prevent the decrease of battery capacity and the decrease of battery cycle life due to eluting the transition metal ion from the positive electrode. It may enlarge the application fields of transition metals such as manganese that have been limited due to the elution into the electrolyte, so the kinds of positive active material may be diversified.

The borate-based anion may prevent thermal runaway in which a battery is damaged due to chemical structural instability in a positive electrode during a charge, so that it may enhance the thermal stability of the battery to prevent performance deterioration. The borate-based anion has good thermal characteristics, and has improved cycle-life characteristics, due to its low irreversible capacity, as repeated cycles, compared to BF₄⁻ or PF₆⁻. Furthermore, the borate-based anion may provide a more stable thin layer (oxide layer) on the surface of the positive active material, and may also provide a more stable SEI (solid electrolyte interface) on the surface of the negative active material, compared to BF₄⁻ or PF₆⁻. The borate-based anion has stability at about 6.0V, but BF₄⁻, PF₆⁻ or imide-based anion decompose at about 4.5 to about 5.5V.

The ionic liquid may be included at about 0.1 wt % to about 15 wt % based on the total amount of the composition.

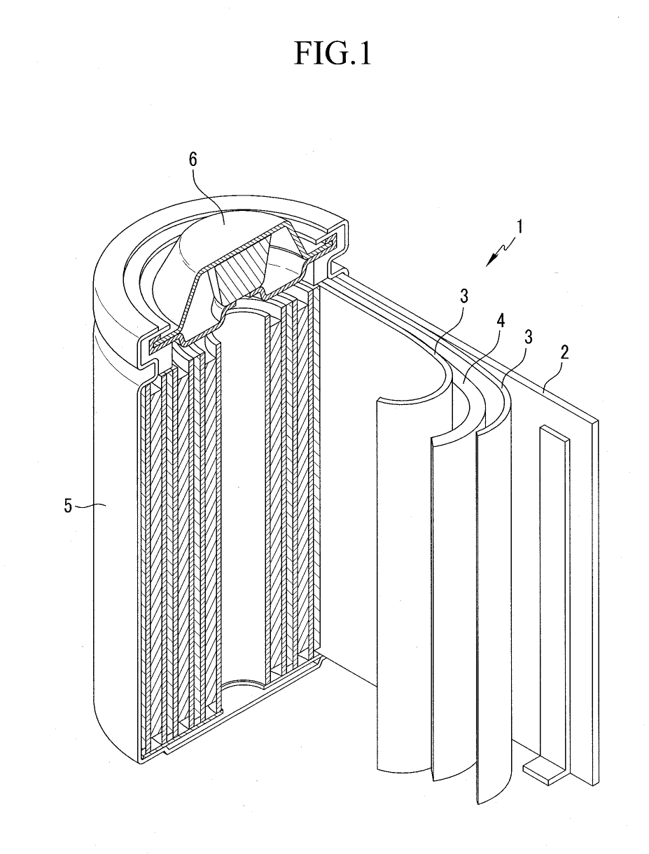

Hereafter, a rechargeable lithium battery according to another embodiment will be described by referring to FIG. 1.

FIG. 1 is a schematic view showing a rechargeable lithium battery according to one embodiment.

Referring to FIG. 1, the rechargeable lithium battery 1 includes a battery cell including a positive electrode 1, a negative electrode 2 facing the positive electrode 4, a separator 3 interposed between the positive electrode 4 and the negative electrode 2, an electrolyte (not shown) impregnating the positive electrode 4, negative electrode 2, and separator 3, a battery case 5, and a sealing member 6 sealing the battery case 5.

The positive electrode 4 includes a current collector and a positive active material layer formed on the current collector.

The current collector may include aluminum foil, but it is not limited thereto.

The positive active material layer may be formed of the composition for a positive electrode, and may be in the form of a slurry.

The positive electrode 5 may be fabricated by a method including mixing the active material, the binder, the ionic liquid including a borate-based anion and optionally conductive material in a solvent, preparing an active material composition and coating the composition on a current collector.

The electrode manufacturing method not described in detail in the present specification. The solvent may be N-methylpyrrolidone but it is not limited thereto.

The negative electrode 2 includes a current collector and a negative active material layer positioned on the current collector.

The current collector may include a copper foil, a nickel foil, a stainless steel foil, a titanium foil, a nickel foam, a polymer substrate coated with conductive metals, and a metal net such as a metal mesh, but is not limited thereto.

The negative active material layer includes a negative active material, a binder, and a conductive material.

For the negative active material, a compound that reversibly intercalates/deintercalates lithium may be used without limitation. Examples of the negative active material include a carbon-based negative active material, compounds being capable of alloying with lithium, transition element oxides, compounds being capable of doping and dedoping lithium, compounds capable of reversibly reacting with lithium, or combinations thereof.

The carbon-based negative active materials may be selected from crystalline carbon, amorphous carbon, or a combination thereof. The crystalline carbon may be non-shaped, sheet, flake, spherical, or fiber shaped natural graphite or artificial graphite. The amorphous carbon may be a soft carbon, a hard carbon, mesophase pitch carbide, fired coke, and so on.

The materials being capable of alloying with lithium include an element selected from the group consisting of Na, K, Rb, Cs, Fr, Be, Mg, Ca, Sr, Ba, Ra, Ti, Ag, Zn, Cd, Al, Ga, In, Si, Ge, Sn, Pb, Sb, Bi, or combinations thereof.

Examples of the transition metal oxide, the material being capable of doping and dedoping lithium, and the material being capable of reacting with lithium ions to form a lithium-containing compound may include vanadium oxide, lithium vanadium oxide, Si, SiO, (0<x<2), a Si-Q alloy (where Q is an element selected from the group consisting of an alkali metal, an alkaline-earth metal, a group 13 element, a group 14 element, a group 15 element, a group 16 element, a transition element, a rare earth element, and a combination thereof, but is not Si), Sn, SnO₂, a Sn-Q alloy (where Q is an element selected from the group consisting of an alkali metal, an alkaline-earth metal, a group 13 element, a group 14 element, a group 15 element, a group 16 element, a transition element, a rare earth element, and a combination thereof, but is not Sn), or mixtures thereof. At least one of these materials may be mixed with SiO₂. The element Q may independently include one selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and a combination thereof.

The binder and conductive material are the same as described above.

The negative electrode 2 may be fabricated by a method including mixing the active material, the binder, and optionally conductive material in a solvent, preparing an active material composition and coating the composition on a current collector.

The electrode manufacturing method is not described in detail in the present specification. The solvent may be N-methylpyrrolidone but it is not limited thereto.

The separator may be a single layer or multilayer, and for example is made of polyethylene, polypropylene, polyvinylidene fluoride, or combinations thereof

The electrolyte includes a non-aqueous organic solvent and a lithium salt.

The non-aqueous organic solvent acts as a medium for transmitting ions taking part in the electrochemical reaction of the battery. The non-aqueous organic solvent may include a carbonate-based, ester-based, ether-based, ketone-based, alcohol-based, or aprotic solvent.

Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), butylene carbonate (BC), and so on.

When the linear carbonate compounds and the cyclic carbonate compounds are mixed, an organic solvent having a high dielectric constant and low viscosity may be provided. The cyclic carbonate compounds and linear carbonate compounds may be mixed together at a volume ratio of about 1:1 to about 1:9.

Examples of the ester-based solvent may include methylacetate, ethylacetate, propylacetate, dimethylacetate, methylpropionate, ethylpropionate, γ-butyrolactone, decanolide, valerolactone, mevalonolactone, caprolactone, and so on. Examples of the ether-based solvent may include dibutyl ether, tetraglyme, diglyme, 1,2-dimethoxy ethane, 1,2-diethoxy ethane, ethoxymethoxy ethane, 2-methyltetrahydrofuran, tetrahydrofuran, and the like, and examples of the ketone-based may solvent include cyclohexanone and the like. Examples of the alcohol-based solvent may include ethanol, isopropyl alcohol, or the like, and examples of the aprotic solvent may include nitriles such as R—CN (wherein R is a C₂ to C₂₀ linear, branched, or cyclic hydrocarbon, a double bond, an aromatic ring, or an ether bond), amides such as dimethylformamide, dioxolanes such as 1,3-dioxolane, sulfolanes, or the like. The non-aqueous organic solvent may be used singularly or in a mixture. When the organic solvent is used in a mixture, the mixture ratio may be controlled in accordance with desirable battery performance.

The non-aqueous organic solvent may further include an aromatic hydrocarbon-based organic solvent in addition to a carbonate-based solvent. The carbonate-based solvents and the aromatic hydrocarbon-based solvents are preferably mixed together in the volume ratio of about 1:about 1 to about 30:about 1.

The aromatic hydrocarbon-based organic solvent may be represented by the following Chemical Formula 1.

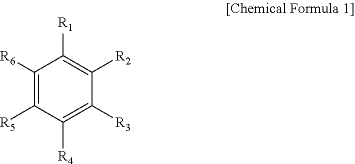

wherein,
R₁ to R₆ are independently hydrogen, a halogen, a C₁ to C₁₀ alkyl, a C₁ to C ₁₀ haloalkyl, or combinations thereof.

The aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, and a combination thereof.

The non-aqueous electrolyte may further include vinylene carbonate or an ethylene carbonate-based compound of the following Chemical Formula 2.

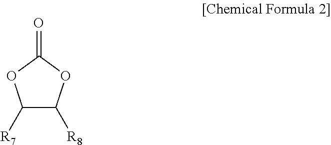

wherein,
R₇ and R₃ are independently hydrogen, a halogen, a cyano group (CN), a nitro group (NO₂), and a C₁ to C₅ fluoroalkyl group, provided that at least one of R₇ and R₈ is a halogen, a nitro group (NO₂), or a C₁ to C₅ fluoroalkyl group and R₇ and R₈ are not simultaneously hydrogen.

The ethylene carbonate-based compound includes difluoroethylene carbonate, chloroethylene carbonate, dichloroethylene carbonate, bromoethylene carbonate, dibromoethylene carbonate, nitroethylene carbonate, cyanoethylene carbonate, or fluoroethylene carbonate. The use amount of the additive for improving cycle life may be adjusted within an appropriate range.

The lithium salt is dissolved in an organic solvent, and supplies lithium ions in the battery and thus operates a basic operation of a rechargeable lithium battery and improves transportation of lithium ions between positive and negative electrodes. Non-limiting examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiCF₃SO₃, LiC₄F₉SO₃, LiC₆H₅SO₃, LiSCN, LiClO₄, LiAlO₂, LiAlCl₄, LiN(CₓF₂ₓ₊₁SO₂)(C_{y}F_{2y+1}SO₂ (where x and y are natural numbers), LiCl, LiI, and LiB(C₂O₄)₂ (lithium bisoxalato borate: LiBOB). The lithium salt may be used in a concentration of about a 0.1 to about 2.0M. When the lithium salt is included at the above concentration range, electrolyte performance and lithium ion mobility may be enhanced due to optimal electrolyte conductivity and viscosity.

The rechargeable lithium battery may further include a separator between a negative electrode and a positive electrode, as needed. Non-limiting examples of suitable separator materials include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

In general, rechargeable lithium batteries may be classified as lithium ion batteries, lithium ion polymer batteries, and lithium polymer batteries according to the presence of a separator and the kind of electrolyte used in the battery. The rechargeable lithium batteries may have a variety of shapes and sizes, including cylindrical, prismatic, or coin-type batteries, and may also be a thin film or rather bulky type depending on its size.

The following examples illustrate the present embodiments in more detail. These examples, however, should not in any sense be interpreted as limiting the scope of the present embodiments.

### Fabrication of Positive Electrode

### EXAMPLE 1

85 wt % of LiMn₂O₄, 5 wt % of poly(vinylidene fluoride-hexafluoropropylene) (P(VdF-HFP) wherein a content of HFP is 5 mol %), 5 wt % of acetylene black, and 5 wt % of lithium bis(oxalato)borate (LiBOB) in N-methylpyrrolidone are mixed to provide a positive active material slurry.

The positive active material slurry is coated on an Al foil and dried, followed by compressing, thereby preparing a positive electrode.

### EXAMPLE 2

85 wt % of LiMn₂O₄, 7 wt % of poly(vinylidene fluoride-hexafluoropropylene) (P(VdF-HFP) wherein a content of HFP is 5 mol %), 7 wt % of acetylene black, and 1 wt % of lithium bis(oxalato)borate(LiBOB) in N-methylpyrrolidone are mixed to provide a positive active material slurry.

The positive active material slurry is coated on an Al foil and dried, followed by compressing, thereby preparing a positive electrode.

### EXAMPLE 3

85 wt % of LiMn₂O₄, 6 wt % of poly(vinylidene fluoride-hexafluoropropylene) (P(VdF-HFP) wherein a content of HFP is 5 mol %), 6 wt % of acetylene black, and 3 wt % of lithium bis(oxalato)borate (LiBOB) in N-methyl pyrrolidone are mixed to provide a positive active material slurry.

The positive active material slurry is coated on an Al foil and dried, followed by compressing, thereby preparing a positive electrode.

### EXAMPLE 4

85 wt % of LiMn₂O₄, 4 wt % of poly(vinylidene fluoride-hexafluoropropylene) (P(VdF-HFP) wherein a content of HFP is 5 mol %), 4 wt % of acetylene black, and 7 wt % of lithium bis(oxalato)borate(LiBOB) in N-methyl pyrrolidone are mixed to provide a positive active material slurry.

The positive active material slurry is coated on an Al foil and dried, followed by compressing, thereby preparing a positive electrode.

### COMPARATIVE EXAMPLE 1

85 wt % of LiMn₂O₄, 7.5 wt % of poly(vinylidene fluoride-hexafluoropropylene) (P(VdF-HFP) wherein a content of HFP is 5 mol %), 7.5 wt % of acetylene black, and 0 wt % of lithium bis(oxalato)borate(LiBOB) in N-methyl pyrrolidone are mixed to provide a positive active material slurry.

The positive active material slurry is coated on an Al foil and dried, followed by compressing, thereby preparing a positive electrode.

### Fabrication of Rechargeable Lithium Battery Cell

A rechargeable lithium battery cell is manufactured with the positive electrode obtained from any one of Examples 1 to 5 and Comparative Example 1, a negative electrode with an artificial graphite negative active material, a separator of polyethylene film, and an electrolyte. As the electrolyte, 1.15M LiPF₆ in an organic solvent in which ethylene carbonate (EC):ethylmethyl carbonate (EMC):diethyl carbonate (DEC) are mixed in a ratio of about 1:1:1 is used.

### Performance Test

Each obtained rechargeable lithium battery cell is charged and discharged two times and then is fully charged the cell. The resulting cells are allowed to stand at 60° C. for 5 days to measure the elution amount of manganese ion (Mn²⁺) into the electrolyte.

The results are shown in the following Table 1.

TABLE 1

| | Mn²⁺ elution amount (ppm) |
|---|---|
| Example 1 | ND |
| Example 2 | 1500 ppm |
| Example 3 | 800 ppm |
| Example 4 | ND |
| Comparative Example 1 | 3000 ppm |

* ND: Not Detectable

As shown in Table 1, in the cases of using the positive electrode obtained from Examples 1 to 4, the manganese ions are less eluted into the electrolyte and the elution amount is remarkably decrease compared to the case of using the positive electrode obtained from Comparative Example 1. From the results, it is understood that the manganese ions may be prevented from being eluted into the electrolyte when including the ionic liquid including a borate-based anion, and the manganese-elution amount may be controlled depending upon the ionic liquid amount.

While the present embodiments have been described in connection with what is presently considered to be practical exemplary embodiments, it is to be understood that the embodiments are not limited to the disclosed embodiments, but, on the contrary, is intended to cover various modifications and equivalent arrangements included within the spirit and scope of the appended claims.

What is claimed is:

1. A composition for a positive electrode of a rechargeable lithium battery, comprising:
a positive active material;
a binder; and
an ionic liquid comprising a borate-based anion.

2. The composition for a positive electrode of a rechargeable lithium battery of claim 1, wherein the borate-based anion comprises one selected from bis(oxalato)borate, difluorooxalatoborate, bis(malonato)borate, bis(perfluoropinacolato)borate, triborate, tetraborate, metaborate, and a combination thereof.

3. The composition for a positive electrode of a rechargeable lithium battery of claim 1, wherein the borate-based anion comprises bis(oxalato)borate.

4. The composition for a positive electrode of a rechargeable lithium battery of claim 1, wherein the ionic liquid comprises a cation selected from a lithium cation, a substituted or unsubstituted imidazolium cation, a substituted or unsubstituted piperidinium cation, a substituted or unsubstituted pyrolidinium cation, a substituted or unsubstituted pyrazolium cation, a substituted or unsubstituted triazolium cation, a substituted or unsubstituted isotriazolium cation, a substituted or unsubstituted thiazolium cation, a substituted or unsubstituted oxazolium cation, a substituted or unsubstituted isooxazolium cation, a substituted or unsubstituted pyridazinium cation, a substituted or unsubstituted pyrimidinium cation, a substituted or unsubstituted pyrazinium cation, a substituted or unsubstituted pyridinium cation, a substituted or unsubstituted isothiazolium cation, a substituted or unsubstituted azathiazolium cation, a substituted or unsubstituted oxothiazolium cation, a substituted or unsubstituted oxaborolium cation, a substituted or unsubstituted dithiazolium cation, a substituted or unsubstituted selenozolium cation, a substituted or unsubstituted oxaphospholium cation, a substituted or unsubstituted pyrollium cation, a substituted or unsubstituted borolium cation, a substituted or unsubstituted furanium cation, a substituted or unsubstituted thiophenium cation, a substituted or unsubstituted pentazolium cation, a substituted or unsubstituted indolium cation, a substituted or unsubstituted indolinium cation, a substituted or unsubstituted tetrazolium cation, a substituted or unsubstituted benzofuranium cation, a substituted or unsubstituted dibenzofuranium cation, a substituted or unsubstituted benzothiophenium cation, a substituted or unsubstituted dibenzothiophenium cation, a substituted or unsubstituted thiadiazolium cation, a substituted or unsubstituted piperazinium cation, a substituted or unsubstituted morpholinium cation, a substituted or unsubstituted pyranium cation, a substituted or unsubstituted annolinium cation, a substituted or unsubstituted phthalazinium cation, a substituted or unsubstituted quinazolinium cation, a substituted or unsubstituted quinazalinium cation, a substituted or unsubstituted quinolinium cation, a substituted or unsubstituted isoquinolinium cation, a substituted or unsubstituted thazinium cation, a substituted or unsubstituted oxazinium cation, a substituted or unsubstituted azaannulenium cation, a substituted or unsubstituted phosphonium cation, a substituted or unsubstituted ammonium cation, or a combination thereof.

5. The composition for a positive electrode of a rechargeable lithium battery of claim 1, wherein the positive active material, the binder and the ionic liquid are respectively included at about 75 wt % to 95 wt %, about 1 wt % to 20 wt %, and about 0.1 wt % to 15 wt % based on the total amount of composition for a positive electrode.

6. The composition for a positive electrode of a rechargeable lithium battery of claim 1, further comprising a conductive material, wherein the conductive material is included at about 0.01 wt% to 20 wt % based on the total amount of the composition for a positive electrode.

7. The composition for a positive electrode of a rechargeable lithium battery of claim 5, wherein the borate-based anion comprises bis(oxalate)borate.

8. A rechargeable lithium battery comprising
a positive electrode, a negative electrode, and an electrolyte,
wherein the positive electrode includes a positive active material, a binder, and an ionic liquid including a borate-based anion.

9. The rechargeable lithium battery of claim 8, wherein the borate-based anion comprises one selected from bis(oxalato)borate, difluorooxalatoborate, bis(malonato)borate, bis(perfluoropinacolato)borate, triborate, tetraborate, metaborate, and a combination thereof.

10. The composition for a positive electrode of a rechargeable lithium battery of claim 9, wherein the borate-based anion comprises bis(oxalato)borate.

11. The rechargeable lithium battery of claim 8, wherein the ionic liquid comprises a cation selected from a lithium cation, a substituted or unsubstituted imidazolium cation, a substituted or unsubstituted piperidinium cation, a substituted or unsubstituted pyrolidinium cation, a substituted or unsubstituted pyrazolium cation, a substituted or unsubstituted triazolium cation, a substituted or unsubstituted isotriazolium cation, a substituted or unsubstituted thiazolium cation, a substituted or unsubstituted oxazolium cation, a substituted or unsubstituted isooxazolium cation, a substituted or unsubstituted pyridazinium cation, a substituted or unsubstituted pyrimidinium cation, a substituted or unsubstituted pyrazinium cation, a substituted or unsubstituted pyridinium cation, a substituted or unsubstituted isothiazolium cation, a substituted or unsubstituted azathiazolium cation, a substituted or unsubstituted oxothiazolium cation, a substituted or unsubstituted oxaborolium cation, a substituted or unsubstituted dithiazolium cation, a substituted or unsubstituted selenozolium cation, a substituted or unsubstituted oxaphospholium cation, a substituted or unsubstituted pyrollium cation, a substituted or unsubstituted borolium cation, a substituted or unsubstituted furanium cation, a substituted or unsubstituted thiophenium cation, a substituted or unsubstituted pentazolium cation, a substituted or unsubstituted indolium cation, a substituted or unsubstituted indolinium cation, a substituted or unsubstituted tetrazolium cation, a substituted or unsubstituted benzofuranium cation, a substituted or unsubstituted dibenzofuranium cation, a substituted or unsubstituted benzothiophenium cation, a substituted or unsubstituted dibenzothiophenium cation, a substituted or unsubstituted thiadiazolium cation, a substituted or unsubstituted piperazinium cation, a substituted or unsubstituted morpholinium cation, a substituted or unsubstituted pyranium cation, a substituted or unsubstituted annolinium cation, a substituted or unsubstituted phthalazinium cation, a substituted or unsubstituted quinazolinium cation, a substituted or unsubstituted quinazalinium cation, a substituted or unsubstituted quinolinium cation, a substituted or unsubstituted isoquinolinium cation, a substituted or unsubstituted thazinium cation, a substituted or unsubstituted oxazinium cation, a substituted or unsubstituted azaannulenium cation, a substituted or unsubstituted phosphonium cation, a substituted or unsubstituted ammonium cation, or a combination thereof.

12. The rechargeable lithium battery of claim 8, wherein the positive electrode comprises a positive active material, a binder, and an ionic liquid at about 75 wt % to about 95 wt %, about 1 wt % to about 20 wt %, and about 0.1 wt % to about 15 wt %, respectively.

13. The rechargeable lithium battery of claim 8, wherein the positive electrode further comprises an oxide layer surrounding a part or the whole of the positive active material and obtained from the borate-based anion.

14. The rechargeable lithium battery of claim 8, wherein the positive electrode further comprises an oxide disposed between the positive active materials and the borate-based anion.

15. A method of making a positive electrode comprising the steps of:
mixing a positive active material, a binder, a conductive material, and a borate-based anion in a solvent to provide a positive active material slurry;
coating the active material slurry on foil;
drying the slurry;
compressing the slurry; thereby preparing a positive electrode.

16. The method of claim 15, wherein the borate-based anion comprises bis(oxalato)borate.

17. The method of claim 15, wherein the binder is poly(vinylidene fluoride-hexafluoropropylene) (P(VdF-HFP)).

18. The method of claim 15, wherein the conductive material is acetylene black.

19. The method of claim 15, wherein the positive active material is LiMn₂O₄.
